(19) United States
(12) Patent Application Publication
(10) Pub. No.: US 2026/0308306 A1
(43) Pub. Date: Oct. 8, 2026

(54) RECYCLEABLE BIOPLASTICS, METHODS OF MANUFACTURE THEREOF AND ARTICLES COMPRISING THE SAME

(71) Applicant: UNIVERSITY OF CONNECTICUT, Farmington, CT (US)

(72) Inventors: Challa Vijaya KUMAR, Ashford, CT (US); Ankarao KALLURI, South Plainfield, NJ (US)

(21) Appl. No.: 19/472,870

(22) PCT Filed: Apr. 10, 2024
(86) PCT No.: PCT/US2024/023907

§ 371 Date: Oct. 6, 2025

Related U.S. Application Data
(60) Provisional application No. 63/458,281, filed on Apr. 10, 2023.

(51) Int. Cl. C08G 18/64; C08G 18/76; C08K 3/04; C08K 5/053

(52) U.S. Cl. CPC C08G 18/6446; C08G 18/7671; C08K 3/041; C08K 3/042; C08K 5/053; C08K 2201/001; C08K 2201/011

(57) ABSTRACT

A crosslinkable composition includes a proteinaceous biopolymer; a crosslinking agent; and a plasticizer. A crosslinked composition includes a crosslinked proteinaceous biopolymer that includes bovine serum albumin, papain, whey, zein, or a combination thereof. A method of manufacturing a crosslinked composition includes blending a proteinaceous biopolymer with a crosslinking agent to form a crosslinkable composition. The crosslinkable composition is then molded and heated to form the crosslinked composition.

### CROSS-REFERENCE TO RELATED APPLICATIONS

This application claims priority to U.S. Provisional Application 63/458,281, filed on Apr. 10. 2023, the contents of which are hereby incorporated by reference in their entirety.

### BACKGROUND OF THE INVENTION

### Field of the Invention

This disclosure relates to recyclable bioplastics, methods of manufacture thereof and articles comprising the same. More specifically, this disclosure relates to chemically crosslinked proteinaceous biopolymers that optionally include recycled plastic products.

### Description of Related Art

Over 90% of naturally-occurring and synthetic organic polymers often end up as waste (hereinafter “plastic waste”) in landfills after being used for their original intended purpose. Examples of such plastic waste include food packaging, computers, plastic furniture, textiles, trash bags, and the like. Plastic waste, once thrown away usually ends up buried deep in landfills where it can take over 500 years to decompose. This waste can sometimes leach harmful chemicals that can spread into groundwater.

Plastic waste that is not recycled often gets washed into streams, rivers, lakes and the sea, where it often interferes with wildlife. In order to minimize the amount of plastic waste that is deposited in landfills, it is desirable to find new methods of recycling plastics in general and in particular plastic waste.

### SUMMARY OF THE INVENTION

A crosslinkable composition includes a proteinaceous biopolymer; a crosslinking agent; and a plasticizer.

A crosslinked composition includes a crosslinked proteinaceous biopolymer that includes bovine serum albumin, papain, whey, zein, or a combination thereof.

A method of manufacturing a crosslinked composition includes blending a proteinaceous biopolymer with a crosslinking agent to form a crosslinkable composition. The crosslinkable composition is then molded and heated to form the crosslinked composition.

### BRIEF SUMMARY OF THE FIGURES

FIG. 1A is a photomicrograph of a zein control film manufactured without any crosslinking agent or plasticizer; and

FIGS. 1B, 1C and 1D are photomicrographs of zeins film having 1 wt % of the crosslinking agent.

### DETAILED DESCRIPTION OF THE INVENTION

Disclosed herein is a biodegradable composition (hereinafter “composition”) that comprises a crosslinked proteinaceous biopolymer. Disclosed herein too is a crosslinkable biodegradable composition (hereinafter “crosslinkable composition”) that comprises a proteinaceous biopolymer and a crosslinking agent.

The composition is crosslinked and is typically a thermoset. A crosslinked composition refers to a material or substance that has been chemically modified to form bonds between its molecular chains. This crosslinking process creates a network structure within the material, which can improve its strength, durability, and resistance to various environmental factors such as heat, chemicals, and mechanical stress. It cannot be completely dissolved in a solvent. It may undergo swelling in a solvent but will not undergo complete dissolution. The composition prior to or during crosslinking may be processed into a film or a shaped article. The film or shaped article may not however, be reformed into another film or another shape after the crosslinking has occurred. The film can be optically transparent or opaque.

Proteins are green, sustainable, biodegradable polymers that upon undergoing crosslinking may be transformed into valuable bioplastics for use in a variety of applications. Soy protein-derived bioplastics differ from other valuable bioplastics, but also present some drawbacks. One of these drawbacks is that soy is a key food source and its industrial conversion to a commercially available bioplastic can destabilize the world food supply.

Manufacturing the recyclable composition offers several advantages, both environmental and economic. It conserves natural resources. Recycling reduces the need for raw materials, such as timber, minerals, and petroleum, thereby conserving natural resources. For example, recycling paper reduces the number of trees cut down for paper production. It reduces energy consumption because recycling typically uses less energy than producing goods from raw materials. It reduces the amount of waste sent to landfills or incinerators, helping to minimize environmental pollution and the need for additional landfill space. It reduces pollution associated with extracting, processing, and manufacturing new materials. For example, recycling plastic reduces the amount of plastic waste that ends up in oceans and ecosystems.

The encapsulation of recyclable materials by the proteinaceous biopolymer prevents the escaping of plasticizers, anti-oxidants, anti-ozonants, and other additives into aquifers and other drinking water systems. Recycling produces fewer greenhouse gas emissions compared to manufacturing products from raw materials. For example, recycling paper reduces carbon dioxide emissions compared to producing paper from virgin wood fibers.

Soy protein is sometimes converted into a hydrolyzed soy protein isolate for making the bioplastic. However, these isolates have no specific molar mass or characteristic structures and hence, the properties of the end product cannot be predicted based on the molecular structure of the isolate.

The disclosed method is advantageous in that an unaltered protein with known structure and molar mass is used thus facilitating control of the material properties in a predictable manner. The proteinaceous biopolymers disclosed herein (and the resulting compositions) do not directly compete with proteins that are used in the manufacture of food products. Alternatively, these proteinaceous biopolymers can also be mass produced in the lab using the well-known recombinant DNA technologies from bacteria at a low cost. This provides further control over the material properties as the architecture of protein sequences can be controlled.

The composition can be used to replace synthetic plastics since it is biodegradable, renewable, green, and sustainable. Because of the crosslinking of the proteinaceous biopolymer, the resultant composition displays high toughness, high impact resistance, tensile strength, and moldability. The resulting composition is also compostable and absorbed back into the earth. It can serve as nutrient for the soil (after being absorbed into the earth) or animals that eat the bioplastic, thereby decreasing the carbon footprint of the product. The composition can replace nearly 100% of the fossil fuel content found in conventional plastics and uses considerably less energy than that used to produce conventional plastics.

The proteinaceous biopolymer prior to crosslinking comprises a synthetically created or naturally occurring biomolecule or macromolecule that comprises one or more long chains of amino acid residues. Proteins differ from one another primarily in their sequence of amino acids, which are dictated by the nucleotide sequence of their genes, and which usually results in protein folding into a specific 3D structure that determines its activity. The proteinaceous biopolymer is biodegradable and can be completely recycled during its lifetime.

Proteins that contain lysine groups (and most proteins do contain multiple lysine residues) as well as those that contain serine groups or cysteine residues may also be used as proteinaceous biopolymer binders that can be crosslinked.

The proteinaceous biopolymer is preferably soluble in water or an alcohol prior to undergoing crosslinking. After being crosslinked, it can be swelled in a suitable solvent, but is no longer completely soluble.

Examples of proteins are glycoproteins, structural proteins, fibrous proteins, enzymes, proteoglycans, peptides, natural polypeptides, synthetic polypeptides, spherical proteins, oligosaccharides, polysaccharides, collagen, gelatin, elastin, zein, wheat gluten, casein, whey, gellan gum, carrageenan, guar gum, psyllium seed gum, yam starch powder, alginate, seaweed flour, tragacanth gum, karaya gum, curdlan, soy alginic acid, carboxymethylcellulose, agar-agar, carrageenans, locust bean gum, gelatin, alginate, arabinoxylan, arrowroot, cassia gum, cellulose, gum Arabic, karaya gum, konjac, kuzu, maltodextrin, marshmallow root, pectin, sodium alginate, starch, xanthan gum, b-glucan, fibrinogen, fibrin, thrombin, collagen, elastin, albumin, keratin, laminine, papain, bovine serum albumin (BSA), avidin, streptavidin, soybean protein, and the like, or a combination thereof.

Preferred proteinaceous biopolymers include bovine serum albumin, papain, whey, zein or a combination thereof. The proteinaceous biopolymers can be used in amounts of 5 to 99.8 wt %, preferably 95 to 99.5 wt %, and more preferably 98 to 99 wt %, based on a total weight of the crosslinkable composition (i.e., the composition prior to crosslinking).

The composition prior to crosslinking is termed a crosslinkable composition. The crosslinkable composition contains a crosslinking agent. The crosslinking agent facilitates a reaction between the polymer chains of the proteinaceous biopolymer and/or between the polymer chains of the proteinaceous biopolymer and those of the recycled polymer. Crosslinking is the formation of chemical links between molecular chains to form a three-dimensional network of connected polymer chains. Crosslinking of proteinaceous biopolymers is sometimes referred to as bioconjugation.

Despite the complexity of the protein structure in the biopolymer, including composition and sequence of 20 different amino acids, only a small number of protein functional groups comprise selectable targets for crosslinking. In fact, just four protein chemical targets account for the vast majority of crosslinking and chemical modification techniques. These are primary amines, carboxyls, sulfhydryls and carbonyls.

Primary amines exist at the N-terminus of each polypeptide chain (called the alpha-amine) and in the side chain of lysine (Lys, K) residues (called the epsilon-amine). Carboxyls (—COOH) exist at the C-terminus of each polypeptide chain and in the side chains of aspartic acid (Asp, D) and glutamic acid (Glu, E). Like primary amines, carboxyls are usually on the surface of protein structure. Sulfhydryls (—SH) exist in the side chain of cysteine (Cys, C). Often, as part of a protein's secondary or tertiary structure, cysteines are joined together between their side chains via disulfide bonds (—S—S—). Carbonyls (—CHO) are used to produce ketone or aldehyde groups. These can be created in glycoproteins by oxidizing the polysaccharide post-translational modifications (glycosylation) with sodium meta-periodate.

Examples of crosslinking agents for the proteinaceous biopolymers include carbodiimides, N-hydroxysuccinimide esters, imidoesters, maleimides, haloacetyls, pyridyl disulfides, hydrazides, alkoxyamines, isocyanates, aryl azides, diazirines, or a combination thereof. Isocyanates are preferred crosslinking agents.

The isocyanate crosslinking agent can be a polyisocyanate having two or more reactive isocyanate functionalities. The polyisocyanate can be a diisocyanate, a triisocyanate, or an isocyanate that has 4 or more reactive isocyanate functionalities.

Examples of polyisocyanates that may be used to crosslink the proteinaceous biopolymer are toluene diisocyanate (TDI), methylene diphenyl diisocyanate (MDI), or a combination thereof.

A functionalizing agent may be added to the composition. The functionalizing agent can be used to modify the proteinaceous biopolymer to facilitate crosslinking with the crosslinking agent. The functionalizing agent after reacting with the proteinaceous biopolymer can be further modified with a neutralizing ion. Examples of neutralizing ions include zinc, sodium, potassium, ammonium, or a combination thereof. Examples of functionalizing agents include an unsaturated carboxylic acid or a derivative of an unsaturated carboxylic acid. The unsaturated carboxylic acid or a derivative of an unsaturated carboxylic acid can facilitate free-radical polymerization when activated by electromagnetic radiation, heat transfer, or a combination of electromagnetic radiation and heat transfer. Examples of unsaturated carboxylic acids include maleic acid, fumaric acid, itaconic acid, acrylic acid, methacrylic acid, crotonic acid, malonic acid, succinic acid, glutaric acid, adipic acid, pimelic acid, suberic acid, azelaic acid, sebacic acids, citraconic acid, or the like, or combinations thereof. Examples of derivatives of unsaturated carboxylic acids are maleic anhydride, acrylic anhydride, methacrylic anhydride, citraconic anhydride, itaconic anhydride, malonic anhydride, succinic anhydride, glutaric anhydride, adipic anhydride, pimelic anhydride, suberic anhydride, azelaic anhydride, methyl acrylate, methyl methacrylate, ethyl acrylate, ethyl methacrylate, butyl acrylate, butyl methacrylate, glycidyl acrylate, glycidyl methacrylate, or the like, or a combination thereof. A preferred reactive group for functionalizing the proteinaceous biopolymer is a succinic anhydride, a methacrylic anhydride, or a combination thereof.

In an embodiment, the functionalizing agent may contain one or more substituents that can provide the proteinaceous biopolymer with various desirable properties. One desirable property is hydrophobicity. Suitable substituents includes one or more alkyl groups, oxygen, nitrogen, sulfur or phosphorus. In an embodiment, the substituent may include an alkyl having 4 to 20 carbon atoms, preferably 7 to 12 carbon atoms.

An exemplary functionalizing agent is an alkylsuccinic anhydride having 8 to 18 carbon atoms. The functionalizing agent may be added in an amount of 1 to 10 wt %, preferably 2 to 5 wt %, based on a total weight of the proteinaceous biopolymer.

The crosslinking agent is present in the crosslinkable composition in an amount of 0.1 to 5 wt %, preferably 0.2 to 2 wt %, and more preferably 0.3 to less than 1 wt %, based on a total weight of the crosslinkable composition.

In an embodiment, the proteinaceous biopolymer may be optionally used as a binder for a recycled material, which is dispersed through a volume of the crosslinked proteinaceous biopolymer. The term recycled material as used herein applies to a material that would under normal circumstances be discharged to a landfill but could be recycled and reused if desired. In other words, the crosslinked proteinaceous biopolymer forms a matrix that encapsulates the recycled material. The recycled material may include a recycled polymer, recycled paper, cardboard, wood packaging and shavings, and the like. The recycled polymer is typically a plastic product that would have ended up in a landfill under normal circumstances. It may be particulate or fibrous waste from the floor of a manufacturing facility, or alternatively, may be a finished product that is normally discharged to a landfill after its useful life is completed.

The proteinaceous biopolymer is one that can interact with the recycled polymer via van der Waals forces, or can form either a hydrogen bond, a covalent bond, an ionic bond, or a combination thereof with the recycled polymer. The proteinaceous polymer and the recycled polymer may therefore exist in the form of a compatibilized blend, or alternatively, may react with one another (via a covalent bond or an ionic bond) to form a copolymer.

In an embodiment, the recycled polymer is pulverized into a fibrous or particulate powder that is dispersed through the volume of the crosslinked proteinaceous biopolymer. The composition may be treated with optional additives and fabricated into 1, 2 or 3-dimensional articles that can be used for commercial purposes.

The recycled polymer (prior to the process of forming the disclosed composition) includes an organic polymer and may originally be in the form of a one, two or three dimensional article (e.g., a fiber, a wire, electrical insulation, crockery and cutlery, a board, a fabric, furniture, exterior body panels of automobiles, automobile bumpers, cookware, and the like). As noted above, the recycled polymer preferably comprises a plastic product that would under normal circumstances be destined for the landfill. It is preferably collected before going to the landfill and is treated to make it suitable for incorporation into the composition. Preferred recycled polymers are in the form of fibers (prior to forming a textile) or in the form of a woven or non-woven textile.

In one embodiment, the woven or non-woven textile may comprise a naturally occurring fiber such as cotton, silk, jute, hemp, coir, bamboo, abaca, coir, lyocell, modal, sisal, and the like, or a combination thereof. In another embodiment, the woven or non-woven textile may comprise a synthetic organic polymer. Organic polymers that are present in one, two or three dimensional articles are listed below.

The organic polymer (that is used as the recycled polymer) may be a thermoplastic polymer, a blend of thermoplastic polymers, a thermosetting polymer, or a blend of a thermoplastic polymer with a thermosetting polymer. The organic polymer may also be a blend of polymers, copolymers, terpolymers, or a combination thereof. The organic polymer can also be an oligomer, a homopolymer, a copolymer, a block copolymer, an alternating block copolymer, a random polymer, a random copolymer, a random block copolymer, a graft copolymer, a star block copolymer, a dendrimer, a polyelectrolyte (polymers that have some repeat groups that contain electrolytes), a polyampholyte (a polyelectrolyte having both cationic and anionic repeat groups), an ionomer, or the like, or a combination thereof.

Examples of thermoplastic polymers present in the recycled polymer includes polyacetals, polyacrylics, polycarbonates, polyalkyds, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether ether ketones, polyether ketone ketones, polybenzoxazoles, polyoxadiazoles, polybenzothiazinophenothiazines, polybenzothiazoles, polypyrazinoquinoxalines, polypyromellitimides, polyguinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polypropylenes, polyethylenes, polyethylene terephthalates, polyvinylidene fluorides, polysiloxanes, or the like, or a combination thereof.

Examples of polyelectrolytes present in the recycled polymer includes polystyrene sulfonic acid, polyacrylic acid, pectin, carrageenan, alginates, carboxymethylcellulose, polyvinylpyrrolidone, or the like, or a combination thereof.

Examples of thermosetting polymers present in the recycled polymer includes epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or the like, or a combination thereof.

The recycled polymer may be added to the composition in various geometrical forms and shapes. It can be added in the form of pulverized micro-particles or micro-fibers; strips, sheets, whiskers, coils, tubes of length and width greater than 5 millimeters; 3-dimensional shapes such as cubes, rectangular cuboids, spheres, pyramids, ellipsoids, and the like, or a combination thereof. In an embodiment, the strips, sheets, whiskers, shavings, coils and/or tubes have an aspect ratio greater than 2, preferably greater than 5 and more preferably greater than 10. Shavings are polymeric residue from machining operations (e.g., drilling, milling, and the like) performed on polymeric components.

In an embodiment, the recycled polymer is pulverized prior to being blended with the proteinaceous biopolymer. The pulverized recycled polymer may be in the form of particulates, shavings or fibers (micro-particles or micro-fibers) have an average particle size of 20 to 300 micrometers, preferably 25 to 250 micrometers and more preferably 50 to 200 micrometers.

In an embodiment, the particles, shavings or fibers recycled polymer after pulverization into particulates may optionally be subjected to a surface treatment to facilitate adhesion or bonding with the proteinaceous biopolymer. Silane coupling agents may be used to facilitate surface treatment of the recycled polymer. Examples of coupling agents are hexamethyldisilazane or trimethylchlorosilane.

The recycled material may also include paper and paper products. Papers include a material made from cellulose fibers derived from wood, rags, or other sources, wood pulp, cotton, jute, bagasse, bamboo, or the like. It is primarily used for writing, printing, drawing, and packaging.

In an embodiment, the recycled material is present in the composition in an amount of 10 to 95 wt %, preferably 15 to 85 wt % and more preferably 20 to 70 wt % of the composition.

In one embodiment, the proteinaceous biopolymer and the crosslinking agent along with the optional recycled polymer are blended together and subjecting to further processing. Plasticizers may optionally be added to the crosslinkable composition prior to the crosslinking. The blending can be dry blending, melt blending, solution blending, or a combination thereof.

Dry blending avoids the use of solvents, while wet blending includes the use of solvents that can partially or completely solvate at least one of the proteinaceous biopolymers and the optional recycled polymer. Melt blending includes melting at least one of the recycled polymer or the proteinaceous biopolymer during blending.

Solvents used for wet blending include water, alcohols, ketones, and the like. Solvents that are non-toxic to the existence of living beings are preferred. Alcohols include methanol, ethanol, butanol, propanol, or a combination thereof. Water and ethanol are preferred solvents. Solvents may optionally be used to manufacture the composition. The composition may be present in the solvent in an amount of 10 to 80 wt %, preferably 25 to 60 wt %, based on a total weight of the crosslinkable composition and the solvent.

Various additives may be added to the crosslinkable composition prior to blending or during blending. These additives include fillers and reinforcing agents, clays, dyes and colorants, glass beads, elastomers, impact modifiers, gelling agents, crushed tires, plasticizers, antioxidants, antiozonants, flame-retardants, thermal-stabilizers, mold release agents, and the like, or a combination thereof.

In an embodiment, the composition may be rendered electrically conducting by adding electrically conducting fillers such as metal particles, carbonaceous particles, electrically conducting ceramic particles, intrinsically conducting fillers, or a combination thereof to the composition. Metal particles include particulate or fibrous particles of copper, aluminum, steel, or a combination thereof. Carbonaceous particles include carbon black, Keltjen black, carbon nanotubes (single wall, double wall, multiwall carbon nanotubes, or a combination thereof), graphite particles and/or platelets, graphene sheets, carbon fibers derived from pitch or polyacrylonitrile, or a combination thereof. Electrically conducting ceramic particles include indium tin oxide, antimony tin oxide, lanthanum-doped strontium titanate (SLT), yttrium-doped strontium titanate (SYT), or a combination thereof. Intrinsically electrically conducting fillers include polyaniline, polythiophene, polyacetylene, polypyrrole, or a combination thereof.

SWNTs used in the composition may be produced by laser-evaporation of graphite, carbon arc synthesis or the high-pressure carbon monoxide conversion process (HIPCO) process. These SWNTs generally have a single wall comprising a graphene sheet with outer diameters of about 0.7 to about 2.4 nanometers (nm). SWNTs having aspect ratios of greater than or equal to about 5, preferably greater than or equal to about 100, more preferably greater than or equal to about 1000 are generally utilized in the composition. While the SWNTs are generally closed structures having hemispherical caps at each end of the respective tubes, it is envisioned that SWNTs having a single open end or both open ends may also be used. The SWNTs generally comprise a central portion, which is hollow, but may be filled with amorphous carbon.

In another embodiment, the SWNTs may comprise a mixture of metallic nanotubes and semi-conducting nanotubes. Metallic nanotubes are those that display electrical characteristics similar to metals, while the semi-conducting nanotubes are those, which are electrically semi-conducting. In general, the manner in which the graphene sheet is rolled up produces nanotubes of various helical structures. Zigzag and armchair nanotubes constitute two possible confirmations. In order to minimize the quantity of SWNTs utilized in the composition, it is generally desirable to have the composition comprise as large a fraction of metallic SWNTs.

MWNTs derived from processes such as laser ablation and carbon arc synthesis that are not directed at the production of SWNTs, may also be used in the compositions. MWNTs have at least two graphene layers bound around an inner hollow core. Hemispherical caps generally close both ends of the MWNTs, but it may be desirable to use MWNTs having only one hemispherical cap or MWNTs, which are devoid of both caps. MWNTs generally have diameters of about 2 to about 50 nm.

Carbon black having a high surface area is preferred for use in the electrode. Carbon black (subtypes are acetylene black, channel black, furnace black, lamp black and thermal black) is a material produced by the incomplete combustion of coal and coal tar, vegetable matter, or petroleum products, including fuel oil, fluid catalytic cracking tar, and ethylene cracking in a limited supply of air. Carbon black is a form of paracrystalline carbon that has a high surface-area-to-volume ratio, albeit lower than that of activated carbon. Carbon black having a surface area of 50 to 1000 m2/gm may be used the composition.

Activated carbon also called activated charcoal, is a form of carbon that has a surface area in excess of 3,000 m²/gm as determined by gas adsorption. It can be used in conjunction with other electrically conducting carbonaceous elements listed herewith.

Graphene is an allotrope of carbon consisting of a single layer of atoms arranged in a hexagonal lattice nanostructure. Graphene that is added to the slurry may be in the form of individual graphene sheets or in the form of a plurality of loosely connected graphene sheets. Each atom in a graphene sheet is connected to its three nearest neighbors by σ-bonds and a delocalised π-bond, which contributes to a valence band that extends over the whole sheet. This is the same type of bonding seen in carbon nanotubes and polycyclic aromatic hydrocarbons, and in fullerenes and glassy carbon. The valence band is touched by a conduction band, making graphene a semi-metal with unusual electronic properties that are best described by theories for massless relativistic particles.

Graphite particles may also be used in the electrically conducting composition. Graphite is a natural manifestation of pure carbon with a hexagonal crystal structure that is arranged in several parallel levels, called graphene layers. In short, graphite particles comprise a plurality of graphene sheets that are arranged to be parallel to each other. This anisotropic structure gives the graphite special properties, such as electrical conductivity or a particular strength along the individual layers. It is extremely heat-resistant with a sublimation point of over 3,800° C., thermally highly conductive and chemically inert.

Graphite oxide (GO), sometimes called graphene oxide, graphitic oxide or graphitic acid, is a compound of carbon, oxygen, and hydrogen in variable ratios, obtained by treating graphite with strong oxidizers and acids for resolving of extra metals. The maximally oxidized bulk product is a yellow solid with a C:O ratio between 2.1:1 and 2.9:1, that retains the layer structure of graphite but with a much larger and irregular spacing. The bulk material spontaneously disperses in basic solutions or can be dispersed by sonication in polar solvents to yield monomolecular sheets, known as graphene oxide by analogy to graphene, the single-layer form of graphite. Graphene oxide sheets exist in the form of strong paper-like materials, membranes, thin films, and composite materials and can be used in the composition.

The electrically conducting fillers are added in amounts of 1 to 20 wt %, preferably 2 to 15 wt %, based on a total weight of the composition. Compositions containing electrically conducting fillers may be electrically conducting. The compositions that contain electrically conducting fillers may be used in electrostatic discharge applications, electromagnetic dissipation applications and electrically conductive applications.

Plasticizers may also be added to the composition. Plasticizers may form hydrogen or electrostatic bonds with the proteinaceous biopolymer that increase the amount of free and freezing bond water retained in the biopolymer. Examples of plasticizers include glycerol, glycerin, glyceryl oleate, oleyl alcohol, polyethylene glycols (e.g., PEG-4, PEG-6, PEG-8, PEG-12, PEG-16, PEG-20, PEG-32, PEG-75), stearic acid, oleic acid, sodium lactate, and the like, or a combination thereof.

In some embodiments, the composition may further comprise one or more humectants. Generally, a humectant is a water soluble solvent and any one of a group of hygroscopic substances with hydrating properties, i.e., used to keep things moist. They often are a molecule with several hydrophilic groups, most often hydroxyl groups; however, amines and carboxyl groups, sometimes esterified, can be used as well.

Non-limiting examples of some humectants include propylene glycol (E1520), hexylene glycol, and butylene glycol; glyceryl triacetate (E1518); vinyl alcohol; neoagarobiose; glycerol/glycerin, sorbitol (E420), xylitol, maltitol (E965), polymeric polyols (e.g., polydextrose (E1200)), quillaia (E999), urea, aloe vera gel, MP diol, alpha hydroxy acids (e.g., lactic acid), and the like, or a combination thereof.

Plasticizers and/or humectants may be used in amounts of 0.1 to 30 wt %, preferably 5 to 25 wt %, based on a total weight of the composition.

Surfactants may also be added to the composition. Surfactants may be amphoteric surfactants, anionic surfactants, cationic surfactants, zwitterionic surfactants, or a combination thereof. An example of a surfactant is sodium dodecyl sulfate.

The proteinaceous biopolymer, the optional recycled polymer (in pulverized or in an unpulverized form) and the crosslinking agent along with the additives may then be blended and molded to form an article. The blending of the proteinaceous biopolymer, the optional recycled polymer and the crosslinking agent can be conducted in a blender such as for example, single or multiple screw extruders, a Buss kneader, a Henschel, helicones, a Ross mixer, a Banbury, roll mills, molding machines such as injection molding machines, vacuum forming machines, blow molding machine, and then like, or a combination thereof.

The crosslinkable composition after blending may be molded into a desired shape. If a solvent is used to facilitate blending, then the crosslinkable composition may be subjected to drying prior to or immediately after being molded. Molding may include compression molding, injection molding, blow molding, vacuum forming, and the like. Articles manufactured from the composition include components for automobiles and aircraft, furniture, household objects such as brushes, combs, footwear, fabrics, plates, forks and spoons, housing for electronics, and the like.

During the molding of the crosslinkable composition, it can be subjected to crosslinking. Crosslinking may be accomplished by raising the temperature of the molded crosslinkable composition. The temperature during crosslinking can be from room temperature (23° C.) to 80° C., preferably 30° C. to 50° C.

The composition can be used to recycle polymeric products (especially textiles) and prevent the proliferation of plastic waste at landfills with the consequent pollution of underground water streams.

The composition may be used to manufacture bioplastic bags that can be used for packaging food, carrying trash and compost. It may be used for single-use or disposable plastic products such as plastic carry bags, bottles, cups, straws, water packets and cling wrap. It may be used in tissue engineering scaffolds, implantable materials, wound healing patches, and biomedical applications. The composition can be used in products that may be used in point of care diagnostics, bio-sensing, enzyme kinetics, and controlled release systems. Low cross-linked bioplastic polymers with protein (BSA) films or hydrogels may be used for the drug or gene delivery systems in the pharmaceutical industry.

Conductive compositions can be used to make flexible and conductive electrode films to fabricate the energy storage devices like bio-battery and bio-ultracapacitor devices.

The composition and a method of manufacturing the composition is exemplified by the following non-limiting example.

### EXAMPLE

### Example 1

This example was conducted to demonstrate several compositions that contain the proteinaceous biopolymer. The proteinaceous biopolymer is one of bovine serum albumin (BSA) or papain, whey or zein protein.

BSA protein stock solution at a concentration of 5 mM (320 mg/ml, pH 9.2) was prepared in a sodium bicarbonate buffer. Films of the composition are fabricated by crosslinking BSA (32% w/v with water) with methylene diphenyl diisocyanate (MDI, <1%), and a plasticizer (25% w/v of ethylene glycol or glycerol) at room temperature.

First, the BSA solution is mixed with MDI at pH 9.2 and stirred for 1 hour followed by adding the plasticizer at various concentrations. The resulting solution is mixed for up to 6 hours in a closed chamber. The reaction mixture was transferred to different molds having flat surfaces of the desired size. The reaction mixture was heated to 40° C., the solvents were left to evaporate for 24 hours and the resulting protein films could be removed with tweezers. The films produced can be transparent and flexible.

The composition and properties are shown in the Table 1 below.

TABLE 1

| | BSA | MDI Mass | | | BSA:MDI | | | |
|---|---|---|---|---|---|---|---|---|
| | Mass | (Stock | | BSA:MDI | Moles | Ethylene | Reaction time | |
| | (Stock | in ml | | Mass | Ratio | glycol | (Sol to gel, | |
| No. | in ml) | of ACN) | | Ratio | (integers) | (ml) | Gel to films) | Films |
| 1 | 2 g (5 ml) | 10 mg | (0.2 ml) | 200:1 | 1:1 | 1 ml | 18-24 | Elastic |
| | | | | | | | | Films |
| 2 | 2 g (5 ml) | 13.33 mg | (0.26 ml) | 150:1 | 1:2 | 1 ml | 12 hrs-24 hrs | Elastic |
| | | | | | | | | Films |
| 3 | 2 g (5 ml) | 20 mg | (0.2 ml) | 100:1 | 1:2.5 | 1 ml | 6-12 hrs | Elastic |
| | | | | | | | | &strong |
| | | | | | | | | Films |
| 4 | 2 g (5 ml) | 40 mg | (0.8 ml) | 50:1 | 1:5 | 1 ml | 15 min (gel) | Brittle and |
| | | | | | | | 30 mints (solid) | strong |
| | | | | | | | | films |
| 5 | 2 g (5 ml) | 40 mg | (0.8 ml) | 20:1 | 1:13 | 1 ml | 5 mints (gel) | Strong |
| | | | | | | | 10 mints (Solid) | polymer |
| 6 | 2 g (5 ml) | 200 mg | (4 ml) | 10:1 | 1:27 | 1 ml | 1 mint (gel) | Strong |
| | | | | | | | 5 mints (solid) | polymer |

In summary, proteins (BSA, papain, whey or zein) are considered one of the most useful sources for producing bioplastics due to their abundance, cost-effectiveness ($1.00 per gram or less), eco-friendly, safe, and efficient processability can be synthesized in large quantities. BSA protein materials display good biocompatibility, biodegradability, low toxicity and hence are environmentally friendly new materials as an alternative to conventional petroleum-derived materials. By using biodegradable materials there is no indication of ecotoxicity or reduced soil quality, in addition, the waste and degraded proteins act as a nutrient to plant growth. Biodegradable films are good systems for the improvement of food quality, shelf life, safety, and functionality. BSA and other proteins used here are proteins that form these bioplastic materials with 3D chemical polymerizations and various engineering applications for the protection of intellectual property rights.

The composition is advantageous in that it reduces problems pertaining to the environmental pollution by fabrics. It resolves weight problems in automobiles, aircraft, furniture, electronics and buildings. It can be used as a replacement for wood, metals or non-degradable polymers. The manufacturing process for producing the composition is fast, green, sustainable, energy efficient and eco-friendly. It can be adhesively bonded (with glue) to wood, plastics, metals and ceramics. The resulting composition is completely recyclable.

### Example 2

This example was conducted to demonstrate the use of BSA as the proteinaceous biopolymer in the manufacture of filter paper nanocomposites. Methylene diphenyl diisocyanate (MDI) is sued as the crosslinking agent. Carbon nanotubes (CNTs) and graphene dispersions were used to impart electrical conductivity to the proteinaceous biopolymer films. Glucose oxidase is an enzyme that catalyzes the oxidation of glucose into gluconic acid and hydrogen peroxide. It is commonly used in various applications, including biosensors for glucose monitoring in diabetes, food and beverage industry for glucose determination, and in the production of gluconic acid, which has applications in food preservation and pharmaceuticals. Alkyl succinic anhydride is used as a The method of manufacturing the BSA films is shown in Table 2.

TABLE 2
Processing conditions

1. Mix BSA + MDI in the desired ratios
2. Wait for 15 minutes by mixing to form uniform polymerization
3. Add the other reagents (Glucose oxidase/CNT/Graphene dispersions)
4. Heat the samples at 60° C. for 1 hour to make the flexible bioplastic
films
5. Peel the films carefully

TABLE 3

| | | C18 succinic | Glucose | | | |
|---|---|---|---|---|---|---|
| | | snhydride | oxidase | | | |
| Sample No. | Protein | (50 mg/mL) | (10 mg/mL) | Graphene | CNT | Comments |
| 7. | 0.5 mL of BSA (250 | No | NA | NA | NA | Brittle films, not |
| | mg/mL) water, pH 9 | | | | | flexible, Control |
| | | | | | | experiment |
| 8. | 0.5 mL of BSA (250 | 8% w/w of C18 | NA | NA | NA | Good films, flexible |
| | mg/mL) water, pH 9 | succinic anhydride | | | | |
| 9. | 0.5 mL of BSA (250 | (200 μL, 10 mg) | 1 mg/mL | NA | NA | Good films, flexible |
| | mg/mL) water, pH 9 | | | | | |
| 10. | 0.5 mL of BSA (250 | | NA | 2.5% | NA | Good films, flexible |
| | mg/mL) water, pH 9 | | | | | and stronger films due |
| | | | | | | to Graphene |
| 11. | 0.5 mL of BSA (250 | | NA | NA | 1.0% | Good films, flexible |
| | mg/mL) water, pH 9 | | | | | and stronger films due |
| | | | | | | to CNT (Carbon |
| | | | | | | nanotubes) |

### Example 3

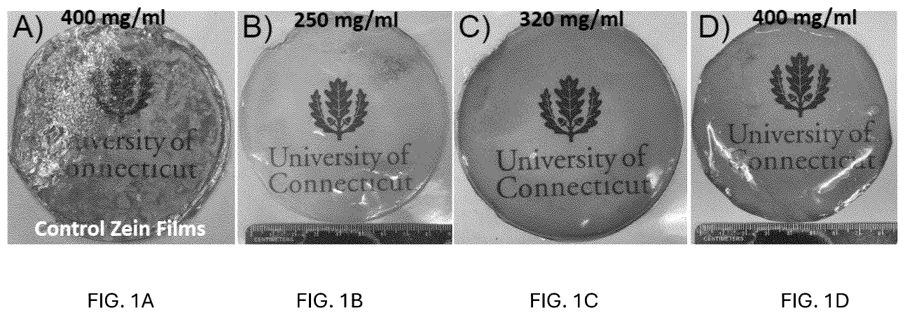

This example was conducted to demonstrate the manufacturing of zein films. Control zein films were first manufactured by dissolving zein (4 grams) in 10 milliliters of an ethanol-water solution that contained 80 wt % of ethanol. The solution contained 0.2 M NaOH and had a pH of 11. No crosslinking agent or plasticizer were added to the ethanol-water solution that contained the zein. The solution containing the polymer was heated to 70° C. and heated for 4 hours before being cast onto a substrate to produce the control film. The film is shown in FIG. 1A.

Crosslinked zein samples containing the plasticizer were also produced as follows. Zein in an amount of 4 grams was dissolved in 10 milliliters of an ethanol-water solution that contained 80 wt % of ethanol. The solution contained 0.2 M NaOH and had a pH of 11. The solution was stirred for 30 minutes at 70° C. to obtain a uniform solution. The crosslinking agent methylene diphenyl diisocyanate (MDI) in an amount of 40 milligrams was added to 0.5 milliliters of acetonitrile and added to the solution containing the zein to form a mixture. The mixture was stirred for 20 minutes to facilitate polymerization of the zein with the MDI. Glycerol (in an amount of 0.5 milliliters) was added as the plasticizer to the polymerized zein in solution. The solution with the polymerized zein and the plasticizer was stirred for 30 minutes while being heated to a temperature of 70° C. The solution was maintained at 70° C. for 4 hours. It was cooled for 10 minutes and then cast on a substrate to obtain a transparent bio-plastic film of the zein protein. The crosslinked samples made using various quantities of zein are shown in the FIGS. 1B, 1C and 1D.

FIGS. 1A, 1B, 1C and 1D are photomicrographs of various zein samples manufactured as detailed above. FIG. 1A is a zein control film manufactured using 400 mg/ml of zein without any crosslinking agent or plasticizer. FIGS. 1B, 1C and 1D represent zein film having 1 wt % of the crosslinking agent (MDI) and having a zein to ethanol-water concentration of 250 mg/ml, 300 mg/ml and 350 mg/ml respectively. The control film of the FIG. 1A (which contained no crosslinker) is brittle, while the films seen in the FIGS. 1B, 1C and 1D that contain the crosslinker and plasticizer are flexible and make strong biofilms. The crosslinked zein films are transparent, elastic and flexible (they can be folded). They can be molded into any desirable shape. They are temperature sensitive (have a melting point greater than 70° C.), thereby forming recyclable protein films.

### Example 4

This example demonstrates the formation of films using crosslinked whey protein isolates (WPI). The content of the whey protein isolate is shown in Table 4.

TABLE 4

| | Content | Molecular | Isoelectric |
|---|---|---|---|
| Proteins | (%) | weight (kD) | pH |
| β-Lactoglobulin (β-Lg) | 48-58 | 18 | 5.4 |
| α-Lactalbumin (α-La) | 13-19 | 14 | 4.4 |
| Glycomacropeptide (GMP) | 12-20 | 8.6 | <3.8 |
| Bovine serum albumin (BSA) | 6 | 66 | 5.1 |
| Immunoglobulin (Igs) | 8-12 | 150 | 5-8 |
| Lactoferrin (LF) | 2 | 77 | 7.9 |
| Lactoperoxidase | 0.5 | 78 | 9.6 |

(Etzel 2004; Kilara and Vaghela 2004; Bonnaillie and Tomasula 2008).

The whey protein isolate (3.2 grams) was taken in an ethanol-water solution containing 80 wt % ethanol. NaOH was added to the ethanol-water solution to bring the pH to 9.2. The crosslinking agent (MDI) was added to the solution such that the WPI to MDI weight ratio is 200:1. 0.5 milliliters of glycerol was added to the solution. A solution of the WPI and MDI was added to a petri dish containing 0.4 milliliters spread uniformly on the bottom. The contents of the petri dish were heated to 80° C. for 1 hour. The dried films were then removed from the petri dish.

The films after heating for 80° C. for one hour were flexible (they could be folded) and could be removed entirely from the petri dish (i.e., they retain their original shape upon being removed from the petri dish).

### Example 5

This example was conducted to demonstrate the use of papain to produce crosslinked films. The films were prepared in two different forms. In the first form, papain was crosslinked using only MDI in acetonitrile (ACN). In the second form, papain was modified using C10 succinic anhydride following which it was crosslinked with MDI in acetonitrile. Each of these methods are discussed below.

In the first form, papain was mixed in water in an amount of 300 mg/ml to form a papain-water solution. 1 wt % of MDI in acetonitrile was added to the papain-water solution. Glycerol (the plasticizer) was added to the papain-water solution in an amount equal to 30 wt % of papain. The solution was then cast and dried to produce crosslinked films. The resulting films were brittle.

In the second form, papain was modified using C10 succinic anhydride was added to water in an amount of 200 mg/ml. The crosslinking agent MDI (25 mg/ml) was added to 0.5 millimeters of acetonitrile. The resulting solution was cast onto a substrate and dried to produce a flexible film. Thus the use of a functionalizing agent such as C10 succinic anhydride followed by crosslinking with MDI produces flexible films, while the use of only MDI produces brittle films despite the use of a plasticizing agent such as glycerol.

### Example 5

Various crosslinked proteinaceous biopolymers samples were produced using the methods detailed in Examples 1-5. These are summarized in Tables 5 and 6 below. Glycerol and ethylene glycol are used as plasticizers. Acetonitrile (ACN) was used as a solvent.

TABLE 5

| Protein | Methylene diphenyl Isocyanate (MDI) | plasticizer | comments |
|---|---|---|---|
| Zein, 400 mg/mL, 80% ethanol, 0.2M NaOH, | MDI solution (50 mg/ml, 0.5-1 w/w | 20-30% w/w | Good films, flexible, |
| pH 11, 70° C., 30 minutes | %) in ACN, 20 minutes mixing | Glycerol/Ethylene | transparent, recycled |
| Zein, 250 mg/mL, 80% ethanol, 0.2M NaOH, | | glycol | Good films, flexible, |
| pH 11, 70° C., 30 minutes | | | transparent, melts at 70° |
| | | | C. for reshaping |
| Whey Protein Isolate, 320 mg/mL, pH 9.2, | | | foldable-flexible films |
| water | | | |
| Papain, 300 mg/mL, pH 9.2, water | | | Brittle films, not flexible |
| Papain modified with C18 Succinic anhydride, | | | Good flexible films |
| 200 mg/mL, pH 9.2, water | | | |

Notes:
Plasticizer: Used Glycerol and ethylene glycol individually gives good flexible films with 20-30% w/w of the proteins
Crosslinker: MDI used 0.5-1% w/w of protein gives flexible and foldable films

TABLE 6

| | Methylene | | | | | |
|---|---|---|---|---|---|---|
| | diphenyl | C18 Succinic | Glucose | Graphene | CNT | |
| Protein | Isocyanate (MDI) | Anhydride | Oxidase (GO) | dispersions | dispersions | comments |
| 0.5 mL of BSA (250 | MDI solution (50 | No C18 | No | No | No | Brittle film, not flexible |
| mg/mL) water, pH 9 | mg/ml, 0.5-1 | | | | | |
| 0.5 mL of BSA (250 | w/w %) in ACN, | 8% w/w of C18 | No | No | No | Good film, flexible |
| mg/mL) water, pH 9 | 20 minutes | succinic anhydride | | | | |
| 0.5 mL of BSA (250 | mixing | | 1 mg/mL | No | No | Good film, |
| mg/mL) water, pH 9 | | | | | | flexible |
| 0.5 mL of BSA (250 | | | No | 2.5% | No | Good films, flexible and |
| mg/mL) water, pH 9 | | | | | | stronger films due to graphene |
| 0.5 mL of BSA (250 | | | No | No | 1.0% | Good films, flexible and |
| mg/mL) water, pH 9 | | | | | | stronger films due to CNT |
| | | | | | | (Carbon nanotubes) |

The Examples shown in Table 6 show that while all of the compositions form films, the use of a functionalizing agent in conjunction with the crosslinking agent produces strong films that are flexible. The use of an enzyme such as glucose oxidase or of a filler such as graphene or carbon nanotubes provides the film with additional stiffness. These fillers enhance mechanical properties.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

1. A crosslinkable composition comprising:
a proteinaceous biopolymer;
a crosslinking agent; and
a plasticizer.

2. The crosslinkable composition of claim 1, where the proteinaceous biopolymer is biodegradable.

3. The crosslinkable composition of claim 1, where the proteinaceous biopolymer comprises glycoproteins, structural proteins, fibrous proteins, enzymes, proteoglycans, peptides, natural polypeptides, synthetic polypeptides, spherical proteins, oligosaccharides, polysaccharides, collagen, gelatin, elastin, zein, wheat gluten, casein, whey, gellan gum, carrageenan, guar gum, psyllium seed gum, yam starch powder, alginate, seaweed flour, tragacanth gum, karaya gum, curdlan, soy alginic acid, carboxymethylcellulose, agar-agar, carrageenans, locust bean gum, gelatin, alginate, arabinoxylan, arrowroot, cassia gum, cellulose, gum Arabic, karaya gum, konjac, kuzu, maltodextrin, marshmallow root, pectin, sodium alginate, starch, xanthan gum, b-glucan, fibrinogen, fibrin, thrombin, collagen, elastin, albumin, keratin, laminine, papain, bovine serum albumin, avidin, streptavidin, soybean protein, and the like, or a combination thereof.

4. The crosslinkable composition of claim 1, where the proteinaceous biopolymer is bovine serum albumin.

5. The crosslinkable composition of claim 1, where the proteinaceous biopolymer is present in an amount of 5 to 99.8 wt %, based on a total weight of the composition.

6. The crosslinkable composition of claim 1, where the crosslinking agent is a carbodiimide, a N-hydroxysuccinimide ester, an imidoester, a maleimide, a haloacetyl, a pyridyl disulfide, a hydrazide, an alkoxyamine, an isocyanate, an aryl/akyl azide, a diazirine, or a combination thereof.

7. The crosslinkable composition of claim 1, where the crosslinking agent is an isocyanate.

8. The crosslinkable composition of claim 1, where the isocyanate is toluene diisocyanate, methylene diphenyl diisocyanate, or a combination thereof.

9. The crosslinkable composition of claim 1, further comprising a recyclable polymer that comprises strips, sheets, whiskers, coils, tubes of length and width greater than 5 millimeters.

10. The crosslinkable composition of claim 1, further comprising a recyclable polymer that comprises particulate or fibrous fillers having particle sizes of 20 to 150 micrometers.

11. The crosslinkable composition of claim 1, further comprising an electrically conducting filler.

12. The crosslinkable composition of claim 1, further comprising a functionalizing agent, where the functionalizing agent comprises a carboxylic acid or a carboxylic acid derivative.

13. A crosslinked composition comprising:
a crosslinked proteinaceous biopolymer that comprises bovine serum albumin, papain, whey, zein, or a combination thereof.

14. The crosslinked composition of claim 13, further comprising a plasticizer.

15. The crosslinked composition of claim 13, wherein the composition is electrically conducting.

16. The crosslinked composition of claim 13, where the composition is optically transparent.

17. The crosslinked composition of claim 13, further comprising a recyclable polymer.

18. An article comprising the crosslinked composition of claim 13.

19. A method of manufacturing a crosslinked composition comprising:
blending a proteinaceous biopolymer with a crosslinking agent to form a crosslinkable composition;
molding the crosslinkable composition; and
heating the crosslinkable composition to form the crosslinked composition.

20. The method of claim 19, further comprising blending the crosslinkable composition with a plasticizer.

21. The method of claim 18, further comprising dispersing an electrically conducting filler in the crosslinkable composition.
